(19) United States
(12) Patent Application Publication
(10) Pub. No.: US 2018/0300072 A1
(43) Pub. Date: Oct. 18, 2018

(54) WATCH WITH EASY ACCESS RECORDING FUNCTIONS

(71) Applicant: Zhenkun Wang, Ashburn, VA (US)

(72) Inventor: Zhenkun Wang, Ashburn, VA (US)

(21) Appl. No.: 15/608,064

(22) Filed: May 30, 2017

(30) Foreign Application Priority Data
Apr. 18, 2017 (CN) 201720401552.2

(51) Int. Cl. G06F 3/06; G06F 1/16

(52) U.S. Cl. CPC G06F 3/0626; G06F 1/163; G06F 1/1671

(57) ABSTRACT

The present invention provides a watch with easy access recording functions, comprising a watch dial, and a back cover, and an one-key-start button. The watch dial includes a scale around the watch dial, and a pointer at the center of the watch dial. A modulation button is on the outer part of the right side of the watch dial. A one-key-start button is on lower part of the left side of the watch dial. A camera, a microphone, and a smart main board are in the inner side of the back cover. A wireless transmission module and a positioning module are located on the smart main board. The wireless transmission module is connected with storage in cloud and a public security reporting system with a wireless transmission mode. The camera and the microphone are hidden in the inner side of the back cover. The positioning module adopts the GPS positioning module or the Beidou positioning module.

### BACKGROUND OF INVENTION

The present invention relates to a smart watch and, more particularly, to a watch with easy access recording functions. Over the years, many difficult crime cases cannot be solved because there is no way to record the crime scene and no way to restore the circumstances of the crime at the time. Even if one has a list of suspects, there is usually lack of evidence of allegations. People have no way to understand the circumstances of the crime at the time, which makes a lot of criminals to be acquit, thus contributing to the criminals chances, and lowing the sense of security of the public. So in this context, we propose a video and audio transmission smart watch. This device is equivalent to the testimony of the dead, and restores the truth and situation of the incident at that time, even if the victim died. The device restores the situation that victims were killed in that incident, so that criminals cannot easy to be released.

### SUMMARY OF THE INVENTION

The present invention provides a watch with easy access recording functions to achieve the aforementioned functions.

According to an aspect of the present invention, there is provided a watch with easy access recording functions. The storage method, which is different from prior art, is uploading the data to the storage in cloud and public security reporting system in a timely manner by internet, and user can set the storage method in advance.

Uploading video and audio information through the usual wear smart watches is quick, convenient, and not cumbersome.

The smart watch can promptly and continuously upload data, and after uploading, if any crime occurs, the whole process of the crime has been recorded. Even if the watch is destroyed by criminals, but the video and audio information and other information of the crime has been recorded and uploaded through the internet. This way is similar to the “black box” (aircraft-specific electronic recording equipment) of aircraft, but the black box need to be retrieved if the plane crashes. This video and audio transmission smart watch does not need to get back. It has recorded and uploaded criminal circumstances already. So that criminals cannot escape the punishment of the law. In fact, the “black box” of aircraft can also upload and saved all the data of aircraft through the internet at any time in the flight. A lot of manpower and resources to find “black box” after the crash of airplane is no need any more.

The audio capturing microphone and video capturing camera are hiding and installing on the side of the watch from 1 o'clock to 3 o'clock (for example wearing on the left hand). For wearing on the right hand, the camera and microphone are located at the gap of the side from 9 o'clock to 11 o'clock. And they are embedded in the side of the watch, so that they have no part protruding outward to achieve the effect of beautiful and concealing.

A one-key-start button is installed at 8 o'clock (for example wearing on the left hand) position, and slightly more protruding than the normal watch surface, but shorter than the other buttons. The advantage is to avoid or to reduce touching by accident.

The mode to start is “double-click”, that is continuous hitting twice in a short time to start, and this special way to start ensures that there is no touch by accident.

The mode to upload is that continently uploads the audio and video data to the location originally setting by user in a timely manner after the device is started. These locations can be user's hard disk in cloud, or police reporting system or other relatives or friends who can help. After storing in hard disk in cloud, even if the user is missing, one can find the reason of disappearance of the user from the user's hard disk in cloud, and restore the situation at that time. If the data is uploaded to the reporting system of police station, or other cloud server of the relatives and friends to cooperate with, not only the situation at the time can be recorded, but also the function timely alarm rescue can be achieved.

A watch having a video and audio transmission function comprises a watch dial and a back cover, wherein the watch dial includes a scale around the watch dial, and includes a pointer at the center of the watch dial. A modulation button is on the outer part of the right side of the watch dial. A one-key-start button is on lower part of the left side of the watch dial. A camera, a microphone, and a smart main board are in the inner side of the back cover. The wireless transmission module is connected with storage in cloud and a public security reporting system with a wireless transmission mode. The wireless transmission module and a positioning module are on the smart main board. The camera and the microphone are hidden in the inner side of the back cover. The positioning module adopts the GPS positioning module or the Beidou positioning module.

The advantages of the present invention is that the device of the invention can effectively capture the audio and video, and can upload to the cloud server or the police reporting system in time to effectively deter the criminals. The utilization effect of the device is good, the privacy is high, and the restore effect is good, and it is also easy to use.

### BRIEF DESCRIPTION OF THE DRAWINGS

The present invention will now be specified with reference to its preferred embodiment illustrated in the drawings, in which:

FIG. 1 is a front view illustrates the structure of an embodiment of the present invention;

FIG. 2 is a 3-D view illustrates the structure of an embodiment of the present invention;

FIG. 3 is an structure illustration of the smart main board inside the device of an embodiment of the present invention;

### DESCRIPTION OF THE INVENTION

The embodiments of the invention will be described below with reference to the drawings.

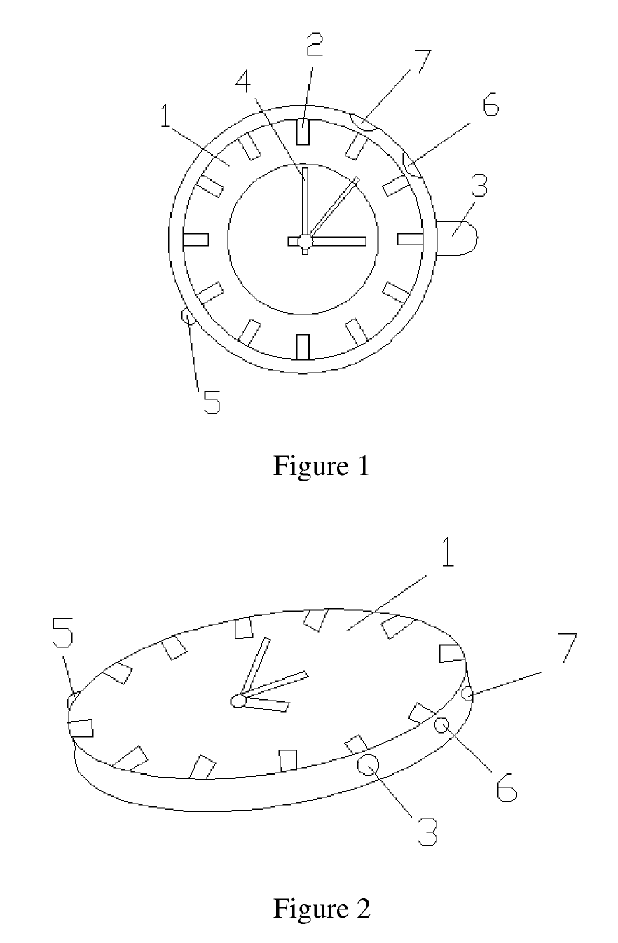

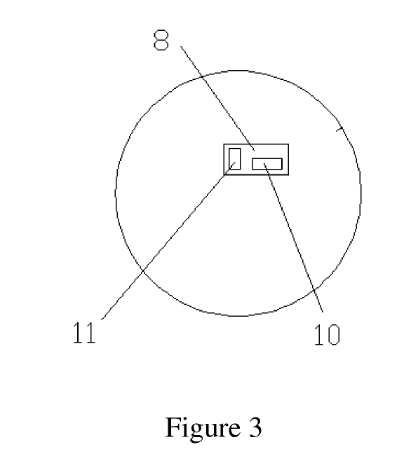

As shown in FIG. 1, FIG. 2, FIG. 3, a watch with easy access recording functions includes a watch dial 1, and a back cover 9. The watch dial 1 includes a scale 2 around the watch dial 1, and includes a pointer 4 at the center of the watch dial 1. A modulation button 3 is on the outer part of the right side of the watch dial 1. A one-key-start button 5 is on lower part of the left side of the watch dial 1. A camera 6, a microphone 7, and a smart main board 8 are in the inner side of the back cover 9. A wireless transmission module 10 and a positioning module 11 are located on the smart main board 8. The wireless transmission module 10 is connected with storage in cloud and a public security reporting system with a wireless transmission mode. The camera 6 and the microphone 7 are hidden in the inner side of the back cover 9. The positioning module 11 adopts the GPS positioning module or the Beidou positioning module.

The storage method, which is different from prior art, of the watch is to upload the data to the cloud storage and/or public security reporting system in a timely manner by internet. Users can set the storage method and storage location/designation in advance. Uploading video and audio information through the usual wear smart watches is quick, convenient, and not cumbersome. The smart watch can be promptly and continuously upload data, and after uploading, if any crime occurs, the whole process of the crime has been recorded. Even if the watch is destroyed by criminals, but the video and audio information and other information of the crime has been recorded and uploaded. This way is similar to the “black box” of aircraft, but the black box need to be retrieved if the plane crashes.

This video and audio transmission smart watch does not need to get back, and it has recorded and uploaded criminal circumstances already; therefore the recorded criminal activity cannot be destroyed. The audio capturing microphone and video capturing camera are hiding and installing on the side of the watch from 1 o'clock to 3 o'clock (for example wearing on the left hand). For wearing on the right hand, the camera and microphone are located at the gap of the side from 9 o'clock to 11 o'clock. And they are embedded in the side of the watch, so that they have no part protruding outward to achieve the effect of beautiful and concealing.

A one-key-start button is installed at 8 o'clock (for example wearing on the left hand) position, and slightly more protruding than the normal watch surface, but shorter than the other buttons. The advantage is to avoid or to reduce touching by accident. The mode to start is “double-click”, that is continuous hitting twice in a short time to start. This special way to start ensures that there is no touch by accident. The mode to upload is that continently uploads the audio and video data to the location originally setting by user in a timely manner after the device is started. These locations can be user's hard disk in cloud, or police reporting system or other relatives or friends who can help. After storing in hard disk in cloud, even if the user is missing, one can find the reason of disappearance of the user from the user's hard disk in cloud, and restore the situation at that time. If the data is uploaded to the reporting system of police station, or other cloud server of the relatives and friends to cooperate with, not only the situation at the time can be recorded, but also the function timely alarm rescue can be achieved.

The above description is a preferred embodiment of the invention and it should be noted that it will be apparent to those skilled in the art that a number of improvements and modifications may be made without departing from the principles of the invention. These improvements and modifications also regarded as the scope of protection of the invention.

What is claimed is:

1. A watch connecting to an external storage, comprising:
a watch body;
a microphone;
a camera;
a smart board performing wireless data transfer with the external storage and controlling and receiving data from the microphone, camera, and other peripherals of the watch; and
an one-key-start button for activating causing the smart board to activate said microphone and camera to obtain audio and video data, and starting continuous uploading of the data to said external storage.

2. The watch of claim 1, wherein said smart board further comprises a wireless transmission module and a positioning module.

3. The watch of claim 2, wherein said positioning module adopts the a GPS positioning module or the a Beidou positioning module to determine position of the watch.

4. The watch of claim 1, wherein said external storage is cloud storage.

5. The watch of claim 1, wherein said external storage is a public security reporting system.

6. The watch of claim 1, wherein said microphone and said camera are located at said watch body at a 1 o'clock position to a 3 o'clock position when the watch has a left-hand design, and said camera and said microphone are located at said watch body at a 9 o'clock position to an 11 o'clock position for when the watch has a right-hand design.

7. The watch of claim 1, wherein said camera and said microphone are embedded within said watch body.

8. The watch of claim 1, wherein said one-key-start button is located at said watch body at an 8 o'clock position of the watch.

9. The watch of claim 1, wherein activating said camera and said microphone, and uploading data is initiated by double clicking said one-key-start button.

10. The watch of claim 1, wherein a user location data is uploaded to said external storage by clicking on said one-key-start button.
